(19) United States
(12) Patent Application Publication
(10) Pub. No.: US 2024/0097221 A1
(43) Pub. Date: Mar. 21, 2024

(54) NICKEL ZINC SECONDARY BATTERY

(71) Applicant: NGK INSULATORS, LTD., Nagoya-shi (JP)

(72) Inventors: Minoru TANIMOTO, Nagoya-City (JP); Takeshi YAGI, Toyohashi-city (JP)

(21) Appl. No.: 18/524,808

(22) Filed: Nov. 30, 2023

Related U.S. Application Data
(63) Continuation of application No. PCT/JP2022/022988, filed on Jun. 7, 2022.

(30) Foreign Application Priority Data
Jun. 11, 2021 (JP) 2021-098351

(51) Int. Cl. H01M 10/52; B01D 53/04; B01J 20/26; B01J 20/28; H01M 10/28; H01M 10/30

(52) U.S. Cl. CPC H01M 10/52; B01D 53/0407; B01J 20/262; B01J 20/28033; H01M 10/28; H01M 10/30; B01D 2253/202; B01D 2257/104

(57) ABSTRACT

There is provided a nickel-zinc secondary battery including, in a sealed container, a positive electrode, a negative electrode, a separator provided between the positive electrode and the negative electrode, and an electrolytic solution. An oxygen absorber is provided in a position where oxygen generated in the positive electrode in the sealed container is absorbable.

### CROSS-REFERENCE TO RELATED APPLICATIONS

This application is a continuation application of PCT/JP2022/022988 filed Jun. 7, 2022, which claims priority to Japanese Patent Application No. 2021-098351 filed Jun. 11, 2021, the entire contents all of which are incorporated herein by reference.

### BACKGROUND OF THE INVENTION

### 1. Field of the Invention

The present disclosure relates to a nickel-zinc secondary battery.

### 2. Description of the Related Art

It is known that in zinc secondary batteries such as a nickel-zinc secondary battery and an air-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life. In order to deal with the problems described above, a battery comprising a layered double hydroxide (LDH) separator that blocks the penetration of zinc dendrite while selectively permeating hydroxide ions has been proposed (see, for example, Patent Literature 1 (WO2016/076047), and Patent Literature 2 (WO2019/124270)). Moreover, LDH-like compounds have being known as hydroxides and/or oxides with a layered crystal structure that cannot be called LDH but are analogous thereto, which exhibit hydroxide ion conductive properties similar to those of a compound to an extent that it can be collectively referred to as hydroxide ion conductive layered compounds together with LDH. For example, Patent Literature 3 (WO2020/255856) discloses a hydroxide ion conductive separator comprising a porous substrate and a layered double hydroxide (LDH)-like compound that clogs up pores in the porous substrate. Patent Literature 4 (WO2019/069760) and Patent Literature 5 (WO2019/077953) have proposed a zinc secondary battery having a configuration in which the whole of a negative electrode active material layer is covered or wrapped up with an electrolyte retention member and an LDH separator, and a positive electrode active material layer is covered or wrapped up with an electrolyte retention member. A nonwoven fabric is used as the electrolyte retention member. It is described that according to such a configuration, complicated sealing and bonding between the LDH separator and a battery container is unnecessary, and hence a zinc secondary battery (especially a stacked-cell battery thereof) capable of preventing zinc dendrite propagation can be produced extremely easily and with high productivity.

By the way, vinylon nonwoven fabrics and separators are commercially available. In particular, a vinylon separator is used in alkaline batteries such as an alkaline manganese battery (alkaline dry battery). Vinylon is a generic term for polyvinyl alcohol (PVA)-based synthetic fibers, and generally refers to synthetic fibers obtained using PVA as a raw material. On the other hand, polyvinyl alcohol used in vinylon is known to deteriorate in air by heating at 200° C. or more, or deteriorate in an alkaline aqueous solution. For example, Non-Patent Literature 1 (see Kiyokazu Imai, “Polyvinyl Alcohol no Rekka (Deterioration of Polyvinyl Alcohol)”, Polymer, 1962, Vol. 11, No. 6, p. 426-430, published on 2011 Sep. 21) describes, about thermal deterioration of PVA in air at 200° C. or more, together with reaction formulas of deterioration mechanisms, that main deterioration reactions are generation of a carbonyl group (oxidation), a double bond (dehydration) (a conjugated enone structure or a polyene structure), a crosslinking bond or branched bond, and split of the main chain. Besides, this literature describes that PVA splits in an alkaline aqueous solution and in the presence of air, but does not split in nitrogen, and that this is because PVA is oxidized by air to generate a carbonyl group in the main chain, and is subsequently split by a retroaldol reaction. Besides, Non-Patent Literature 2 (Shuji Matsuzawa, “Polyvinyl Alcohol no Bunkai to Hashikake (Decomposition and Crosslinking of Polyvinyl Alcohol)”, Polymer, 1963, Vol. 12, No. 4, P. 283-287, published on 2011 Sep. 21) describes that PVA is decomposed when heated at 200° C. or more in air, and describes, together with reaction formulas, a reaction mechanism in which when a ketone group is once formed by oxidation in air, PVA is decomposed, an aldehyde group is formed in the decomposed portion, and PVA having this aldehyde group is further decomposed. Besides, this literature also describes, together with reaction formulas, that when PVA is boiled in an alkaline aqueous solution, a retroaldol reaction is caused, and the thus generated end group would be an aldehyde group, and that PVA having a carbonyl group introduced into the main chain excluding ends is decomposed completely similarly through a retroaldol reaction.

### CITATION LIST

### Patent Literature

Patent Literature 1: WO2016/076047
Patent Literature 2: WO2019/124270
Patent Literature 3: WO2020/255856
Patent Literature 4: WO2019/069760
Patent Literature 5: WO2019/077953
Patent Literature 6: JP2000-037820A
Patent Literature 7: JP2006-334467A
Patent Literature 8: WO2008/140004
Patent Literature 9: JP2002-35579A
Patent Literature 10: JPH5-7773A
Patent Literature 11: JP2003-79354A
Patent Literature 12: JP2005-8699A
Patent Literature 13: JP2008-221065A
Patent Literature 14: J P2011-184482
Patent Literature 15: WO2006/101020
Patent Literature 16: JP2012-207234A
Patent Literature 17: WO2013/187455

### Non-Patent Literature

Non-Patent Literature 1: Kiyokazu Imai, “Polyvinyl Alcohol no Rekka (Deterioration of Polyvinyl Alcohol)”, Polymer, 1962, Vol. 11, No. 6, p. 426-430, published on 2011 Sep. 21, Online ISSN 2185-9825, Print ISSN 0454-1138, https://doi.org/10.1295/kobunshi.11.426, https://www.jstage.jst.go.jp/article/kobunshi1952/11/6/11_6_426/_article/-char/ja
Non-Patent Literature 2: Shuji Matsuzawa, “Polyvinyl Alcohol no Bunkai to Hashikake (Decomposition and Crosslinking of Polyvinyl Alcohol)”, Polymer, 1963, Vol. 12, No. 4, p. 283-287, published on 2011 Sep. 21, Online ISSN 2185-9825, Print ISSN 0454-1138, https://doi.org/10.1295/kobunshi.12.283, https://www.jstage.jst.go.jp/article/kobunshi1952/12/4/12_4_283/_article/-char/ja

### SUMMARY OF THE INVENTION

By providing the above-described countermeasures against dendrite, cycle life of a nickel-zinc secondary battery can be elongated. The life of a nickel-zinc secondary battery depends, however, not only on the cycle life but also on calendar life. Therefore, improvement of calendar life of a nickel-zinc secondary battery is demanded.

The inventors have now found that calendar life can be significantly improved by providing an oxygen absorber inside a nickel-zinc secondary battery.

Accordingly, an object of the present invention is to provide a nickel-zinc secondary battery having significantly improved calendar life.

The present invention provides the following aspects.

### [Aspect 1]

A nickel-zinc secondary battery, comprising, in a sealed container, a positive electrode, a negative electrode, a separator provided between the positive electrode and the negative electrode, and an electrolytic solution, wherein an oxygen absorber is provided in a position where oxygen generated in the positive electrode in the sealed container is absorbable.

### [Aspect 2]

The nickel-zinc secondary battery according to aspect 1, wherein the position where oxygen generated in the positive electrode is absorbable is at least one selected from the group consisting of a surface or surrounding of the positive electrode, a surface or surrounding of the negative electrode, a position between the positive electrode and the negative electrode, a surface or surrounding of the separator, an inner wall of the sealed container, a surface of a positive electrode current collector tab extending from the positive electrode, a surface of a negative electrode current collector tab extending from the negative electrode, and an extra space in the sealed container.

### [Aspect 3]

The nickel-zinc secondary battery according to aspect 1 or 2, wherein the oxygen absorber is at least one selected from the group consisting of a metal powder, titanium dioxide, cerium oxide, a transition metal salt, a ferrous salt, a dithionite salt, zeolite, vinylon, benzenetriol, a polyhydric phenol compound, a polyhydric alcohol compound, an ascorbic acid compound, a cyclohexene compound, a polyene-based polymer having an unsaturated double bond, and an ethylene-vinyl alcohol copolymer.

### [Aspect 4]

The nickel-zinc secondary battery according to any one of aspects 1 to 3, wherein the oxygen absorber is in the form of a nonwoven fabric, and the positive electrode and/or the negative electrode is covered with the nonwoven fabric.

### [Aspect 5]

The nickel-zinc secondary battery according to aspect 4, wherein the nonwoven fabric contains vinylon.

### [Aspect 6]

The nickel-zinc secondary battery according to any one of aspects 1 to 5, wherein the positive electrode contains nickel hydroxide and/or nickel oxyhydroxide, and the negative electrode contains zinc and/or zinc oxide.

### BRIEF DESCRIPTION OF THE DRAWINGS

FIG. 1 is a schematic cross-sectional view illustrating an example of a nickel-zinc secondary battery of the present invention.

FIG. 2 is a view schematically illustrating an example of A-A′ cross section of the nickel-zinc secondary battery shown in FIG. 1.

FIG. 3 is a view conceptually illustrating a storage deterioration mechanism in a nickel-zinc secondary battery.

FIG. 4 is a view of optical microscope images (bright-field observation images in upper portions, dark-field observation images in lower portions) obtained by observation of a cross section of a negative electrode of a nickel-zinc secondary battery produced in Example 2 (comparative) at an initial time point (0th day), and time points after storing the battery at 65° C. for 30 days, 60 days, 90 days, and 120 days.

FIG. 5 is a view of optical microscope images (bright-field observation image in upper portion, dark-field observation images in lower portion) obtained by observation of the cross section of the negative electrode of the nickel-zinc secondary battery produced in Example 2 (comparative) after storage at 65° C. for 120 days.

FIG. 6 is a view of optical microscope images (bright-field observation image in upper portion, dark-field observation images in lower portion) obtained by observation of a cross section of a negative electrode of a nickel-zinc secondary battery produced in Example 3 after storage at 65° C. for 120 days.

### DETAILED DESCRIPTION OF THE INVENTION

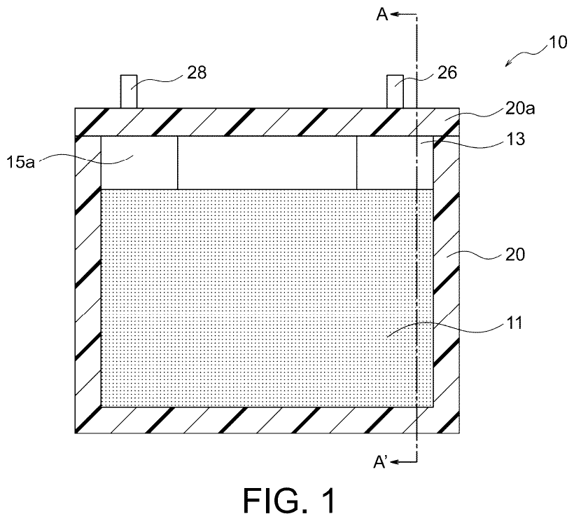

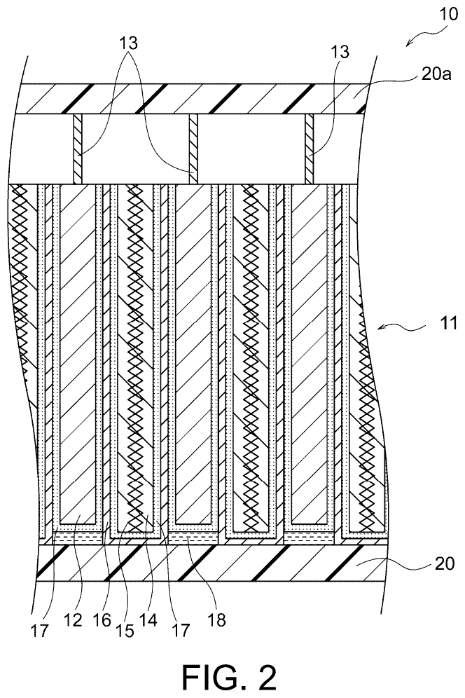

FIGS. 1 and 2 illustrate one aspect of a nickel-zinc secondary battery of the present invention. The nickel-zinc secondary battery 10 illustrated in FIGS. 1 and 2 includes battery components 11 housed in a sealed container 20, and the battery components 11 include a positive electrode 12, a negative electrode 14, a separator 16 provided between the positive electrode 12 and the negative electrode 14, and an electrolytic solution 18. Then, an oxygen absorber 17 is provided in a position where oxygen generated in the positive electrode 12 in the sealed container 20 is absorbable. When the oxygen absorber 17 is thus provided inside the nickel-zinc secondary battery 10, calendar life can be significantly improved. Specifically, the life of a nickel-zinc secondary battery depends not only on cycle life but also on calendar life as described above. Therefore, the calendar life of a nickel-zinc secondary battery is demanded to be improved. In this regard, reduction of calendar life due to performance deterioration caused through long-term storage is caused because capacity differs between the positive electrode and the negative electrode due to loss of negative electrode capacity caused by the long-term storage, and the present invention can suppress this problem by providing the oxygen absorber 17 inside the nickel-zinc secondary battery 10. Specifically, oxygen generated in the positive electrode 12 can be absorbed by the oxygen absorber 17 to suppress capacity consumption in the negative electrode 14, and thus, the problem of calendar life can be solved. This mechanism will now be described.

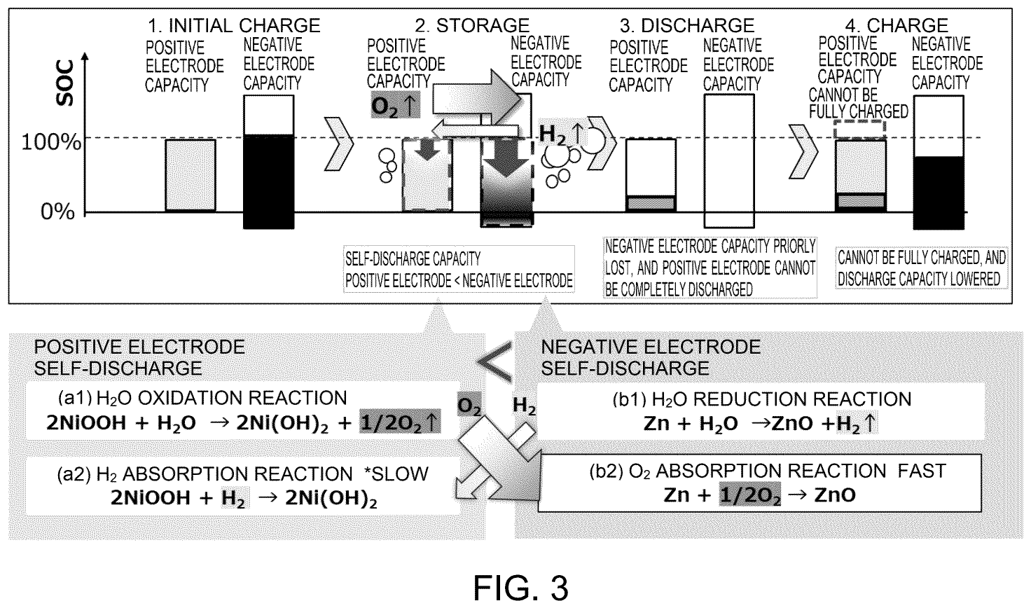

FIG. 3 conceptually illustrates a storage deterioration mechanism in a nickel-zinc secondary battery. As illustrated in FIG. 3, the storage deterioration mechanism is described as including four stages of “1. Initial Charge”, “2. Storage”, “3. Discharge”, and “4. Charge”. First, in an initial stage, as illustrated as “1. Initial Charge” in the drawing, the battery is usually constituted to have residual capacity mounted in the negative electrode so that the positive electrode can be completely discharged, and hence, even when the battery is charged to 100% SOC with respect to the positive electrode capacity, the negative electrode still has allowance capacity. Next, the charged battery is stored. During the storage, the following self-discharge reaction gradually progresses as illustrated in “2. Storage” in the drawing:
<Positive Electrode Self-discharge Reaction>
   Oxidation reaction of H₂O

2NiOOH+H₂O→2Ni(OH)₂+1/2O₂↑ (a1)
H₂ absorption reaction (slow)

2NiOOH+H₂→2Ni(OH)₂ (a2)
<Negative Electrode Self-discharge Reaction>
   H₂O reduction reaction

Zn+H₂O→ZnO+H₂↑(b1)
O₂ absorption reaction (fast)

Zn+1/2O₂→ZnO (b2)

In this self-discharge, the amount of consumption of negative electrode discharge capacity is larger than the amount of consumption of positive electrode discharge capacity during the storage, and therefore, residual capacity is decreased in a larger amount in the negative electrode than in the positive electrode. This is because, as illustrated in FIG. 3, the O₂ absorption reaction (formula (b2)) in the negative electrode self-discharge reaction is faster than the H₂ absorption reaction (formula (a2)) in the positive electrode self-discharge reaction. In other words, generation and absorption of oxygen (O₂) through the formulas (a1) and (b2) proceed faster than generation and absorption of hydrogen (H₂) through the formulas (b1) and (a2). Then, when the battery is discharged after the storage, as illustrated in “3. Discharge” in the drawing, the capacity is smaller in the negative electrode than in the positive electrode in some cases. In such a case, the negative electrode capacity is priory lost, and hence, the positive electrode cannot be completely discharged. When charge is performed in this stage, as illustrated in “4. Charge” in the drawing, the battery cannot be fully charged because mounting capacity of the positive electrode is reached, which lowers discharge capacity. Accordingly, repetition of the procedures of “2. Storage” to “4. Charge” makes it impossible to fully charge the battery, and hence decrease of charge capacity and lowering of discharge capacity proceed, resulting in reaching the end of life.

Thus, a factor most largely affecting calendar life reduction is probably consumption of the negative electrode discharge capacity larger than consumption of the positive electrode discharge capacity due to a self-discharge reaction. In this regard, a cause of the consumption of the negative electrode discharge capacity can be that although oxygen and hydrogen are generated respectively in the positive electrode and the negative electrode through electrolysis of water, the reaction of absorbing, by the negative electrode, the oxygen generated in the positive electrode (formula (b2)) has not been conventionally dealt with. As a result, a state where the generation and absorption of oxygen through the formulas (a1) and (b2) proceeds faster than the generation and absorption of hydrogen through the formulas (b1) and (a2) is left unresolved, which reduces calendar life. Therefore, in the present invention, the oxygen absorber 17 is provided within the nickel-zinc secondary battery 10 as illustrated in FIG. 2, and thus, the oxygen absorber 17 is caused to absorb oxygen generated in the positive electrode 12 through the formula (a1). In this manner, the progress of the oxygen absorption reaction through the formula (b2), which is probably the factor most largely affecting calendar life reduction, can be effectively suppressed. As a result, the calendar life of the nickel-zinc secondary battery can be significantly improved.

The oxygen absorber 17 is provided in a position where oxygen generated in the positive electrode 12 in the sealed container 20 is absorbable. Accordingly, the oxygen absorber 17 is provided to cover the surfaces or surroundings of the positive electrode 12 and the negative electrode 14 in FIGS. 1 and 2, but the position is not limited to this but may be any arbitrary position as long as oxygen within the sealed container 20 can be absorbed. Preferable examples of the position where oxygen generated in the positive electrode 12 is absorbable include the surface or surrounding of the positive electrode 12, the surface or surrounding the negative electrode 14, a position between the positive electrode 12 and the negative electrode 14, the surface or surrounding of the separator 16, the inner wall of the sealed container 20, the surface of a positive electrode current collector tab 13 extending from the positive electrode 12, the surface of a negative electrode current collector tab 15a extending from the negative electrode 14, an extra space (such as an upper extra space and/or a low extra space) in the sealed container 20, and an arbitrary combination thereof. It is noted that an extra space means a space in the sealed container 20 not occupied by the battery constituting members such as the positive electrode 12, the negative electrode 14, and the separator 16. The position is particularly preferably the surface or surrounding of the positive electrode 12, the surface or surrounding of the negative electrode 14, and/or the surface or surrounding of the separator 16 as illustrated in FIG. 2, and most preferably the surface or surrounding of the positive electrode 12, and/or the surface or surrounding of the negative electrode 14. Thus, oxygen generated in the positive electrode 12 can be contacted with the oxygen absorber 17 before reaching the negative electrode 14. In other words, oxygen can be absorbed by the oxygen absorber 17 before being consumed in an oxidation reaction of metal zinc in the negative electrode 14, and as a result, the amount of oxygen reaching the negative electrode 14 can be effectively decreased. In this case, the oxygen absorber 17 is preferably a nonwoven fabric. In any case, since it is preferable to cause the oxygen absorber 17 to absorb oxygen before oxygen absorption in the negative electrode 14, it is deemed that a position of providing the oxygen absorber 17 closer to the positive electrode 12 is more effective (no matter whether or not it is a nonwoven fabric).

The oxygen absorber 17 is not especially limited as long as it is a material capable of absorbing, adsorbing or capturing oxygen, and may be any of various known materials. Examples of the oxygen absorber 17 include a metal powder, titanium dioxide, cerium oxide, a transition metal salt, a ferrous salt, a dithionite salt, zeolite, vinylon, benzenetriol, a polyhydric phenol compound, a polyhydric alcohol compound, an ascorbic acid compound, a cyclohexene compound, a polyene-based polymer having an unsaturated double bond, an ethylene-vinyl alcohol copolymer, and a combination thereof. Specific examples of these oxygen absorbers 17 include those shown in the following table.

TABLE 1
Examples of Oxygen Absorber

| | | | Patent Literature disclosing | |
|---|---|---|---|---|
| | | | specific example | |
| | | | | Patent |
| Classification | Material | Specific example | Publication No. | Literature |
| Inorganic | Metal powder such as | Reducible iron, reducible | JP2000-037820A | 6 |
| substance | iron powder | zinc, reducible tin | | |
| | Titanium dioxide | | JP2006-334467A | 7 |
| | Cerium oxide | | WO2008/140004 | 8 |
| | Transition metal salt | Transition metal salts of stearic | JP2002-35579A | 9 |
| | | acid, dimethyldithiocarbamic acid, | | |
| | | acetyl acetonate, hexoate, oleic acid, | | |
| | | linoleic acid, linolenic acid, | | |
| | | naphthenic acid, or tall oil fatty acid | | |
| | | (examples of transition metals: | | |
| | | Co, Mn, Fe, or Cu) | | |
| | Ferrous salt | Ferrous sulfate, ferrous chloride, | JPH5-7773A | 10 |
| | | ferrous hydroxide | | |
| | Dithionite salt | | | |
| | Zeolite | | | |
| Organic | Vinylon | | | |
| compound | Benzenetriol | Pyrogallol, hydroxyquinol, phloroglucinol | | |
| | Polyhydric phenol | Phenol, catechol, gallic acid, | JP2003-79354A | 11 |
| | compound | resorcinol, hydroquinone, cresol, | | |
| | | tannic acid | | |
| | Polyhydric alcohol | Glycerin, ethylene glycol, propanediol | JP2005-8699A | 12 |
| | compound | | | |
| | Ascorbic acid | Ascorbic acid, sodium ascorbate, | JP2008-221065A | 13 |
| | compound | sodium erythorbate | | |
| | Cyclohexene | Tetrahydrophthalic acid or | JP2011-184482A | 14 |
| | compound | derivative thereof etc. | | |
| | Polyene-based polymer | Conjugated diene polymer, butadiene | WO2006/101020 | 15, 16 |
| | having unsaturated | | JP2012-207234A | |
| | double bond | | | |
| | Ethylene-vinyl alcohol | EVOH resin | WO2013/187455 | 17 |
| | copolymer | | | |

The form of the oxygen absorber 17 is not especially limited and may be appropriately selected in accordance with the form and type of the oxygen absorber to be used, and can be any of various forms including a fabric product such as a nonwoven fabric, a powder, a paste, a coating, a film, a plate, a tablet, and a bulk.

The oxygen absorber 17 is preferably in the form of a nonwoven fabric. It is noted that the term “nonwoven fabric” used herein refers to a sheet-shaped product obtained by entangling, without weaving, fibers with one another, and encompasses not only those designated as nonwoven fabrics but also those designated as paper, namely, how it is called does not matter. In addition, it is preferable that the positive electrode 12 and/or the negative electrode 14 is covered with the oxygen absorber 17 in the form of a nonwoven fabric as illustrated in FIG. 2. In this manner, oxygen generated in the positive electrode 12 can be contacted with the oxygen absorber 17 before reaching the negative electrode 14. In other words, oxygen can be absorbed by the oxygen absorber 17 before being consumed in an oxidation reaction of metal zinc in the negative electrode 14, and as a result, the amount of oxygen reaching the negative electrode 14 can be effectively reduced. In this case, a material of the nonwoven fabric used as the oxygen absorber 17 is not especially limited as long as it is a fiber material capable of absorbing, adsorbing or capturing oxygen, and is preferably an alcohol compound or a material derived therefrom because an oxygen absorption effect through an oxidation reaction can be expected, and is particularly preferably vinylon. Vinylon is a generic term for polyvinyl alcohol (PVA)-based synthetic fibers. In other words, the nonwoven fabric used as the oxygen absorber 17 particularly preferably contains vinylon. A commercially available vinylon separator (nonwoven fabric) is commercially available, and can be used as the nonwoven fabric. In a vinylon nonwoven fabric, dehydration and split are caused through oxidation in the presence of oxygen and an alkaline electrolytic solution, and hence the nonwoven fabric used as the oxygen absorber 17 absorbs oxygen before oxidation of metal zinc in the negative electrode 14, and thus, decrease of metal zinc in the negative electrode 14 can be effectively suppressed. As described above, polyvinyl alcohol used in vinylon is known to be deteriorated by heating at 200° C. in air, and deteriorated in an alkaline aqueous solution (see Non-Patent Literatures 1 and 2), but in the present embodiment, vinylon is used as the oxygen absorber 17 for positively making use of such properties regarded as disadvantages. As described above, the problem of calendar life is caused because oxygen on the positive electrode 12 side generated in charge reaches zinc metal in the negative electrode 14 to oxidize the metal zinc, and therefore, the entire amount of metal zinc is decreased to reverse the capacities of the positive electrode 12 and the negative electrode 14. In this regard, when a vinylon nonwoven fabric is used, oxygen generated in the positive electrode 12 is consumed by an oxidation reaction of the nonwoven fabric itself so that the capacity consumption in the negative electrode 14 can be suppressed, resulting in particularly effectively solve the problem of calendar durability. The material constituting the nonwoven fabric is, however, not limited to vinylon, but as described above, an alcohol compound or a material derived therefrom can be expected to exhibit the oxygen absorption effect through an oxidation reaction in the same manner as vinylon. Besides, the oxygen absorber 17 in the form of a nonwoven fabric can be used in various arrangements such as an arrangement where it is provided between the positive electrode 12 and the negative electrode 14 together with the separator 16 in addition to the arrangement where it covers the positive electrode 12 and/or the negative electrode 14 as illustrated in FIG. 2.

The positive electrode 12 contains a positive electrode active material. The positive electrode active material preferably contains nickel hydroxide and/or nickel oxyhydroxide. Representatively, it is preferable that the positive electrode 12 further includes a positive electrode current collector (not shown), and that the positive electrode current collector has the positive electrode current collector tab 13 extending from an end (for example, an upper end) thereof. A preferred example of the positive electrode current collector includes a nickel porous substrate such as a foam nickel plate. In this case, for example, when a paste containing an electrode active material such as nickel hydroxide is uniformly applied on a nickel porous substrate, and the resultant is dried, a positive electrode plate including a positive electrode/positive electrode current collector can be favorably produced. At this point, it is also preferred that the dried positive electrode plate (namely, the positive electrode/positive electrode current collector) is subjected to pressing to prevent the electrode active material from coming off and to improve electrode density. Although the positive electrode 12 illustrated in FIG. 2 includes a positive electrode current collector (of, for example, foam nickel), it is not illustrated therein. This is because the positive electrode current collector and the positive electrode active material are completely mixed in a nickel-zinc secondary battery, and hence the positive electrode current collector cannot be individually illustrated. The nickel-zinc secondary battery 10 preferably further includes a positive electrode current collector plate connected to a tip of the positive electrode current collector tab 13, and more preferably, a plurality of positive electrode current collector tabs 13 are connected to one positive electrode current collector plate. In this manner, current collection can be space efficiently conducted with a simple configuration, and connection to a positive electrode terminal 26 is also eased. Besides, the positive electrode current collector plate itself may be used as the positive electrode terminal 26.

The positive electrode 12 may contain an additive that is at least one selected from the group consisting of a silver compound, a manganese compound, and a titanium compound, and thus, a positive electrode reaction for absorbing hydrogen gas generated through self-discharge reaction can be accelerated. Besides, the positive electrode 12 may further contain cobalt. Cobalt is contained in the positive electrode 12 preferably in the form of cobalt oxyhydride. In the positive electrode 12, cobalt functions as a conductive auxiliary agent to contribute to improvement of charge/discharge capacity.

The negative electrode 14 includes the negative electrode active material. The negative electrode active material preferably contains zinc and/or zinc oxide. The zinc may be contained in any form of a zinc metal, a zinc compound, and a zinc alloy as long as it has electrochemical activity suitable for the negative electrode. Preferred examples of the negative electrode material include zinc oxide, a zinc metal, and calcium zincate, and a mixture of a zinc metal and zinc oxide is more preferred. The negative electrode active material may be in the form of a gel, or may be mixed with the electrolytic solution 18 to obtain a negative electrode mixture. For example, a gelled negative electrode can be easily obtained by adding an electrolytic solution and a thickener to a negative electrode active material. Examples of the thickener include polyvinyl alcohol, polyacrylate, CMC, and alginic acid, and polyacrylic acid is preferred because of excellent chemical resistance to strong alkali.

As the zinc alloy, a zinc alloy containing neither mercury nor lead, known as mercury-free zinc alloy, can be used. For example, a zinc alloy containing 0.01 to 0.1% by mass of indium, 0.005 to 0.02% by mass of bismuth, and 0.0035 to 0.015% by mass of aluminum is preferred because it has an effect of inhibiting hydrogen gas generation. In particular, indium and bismuth are advantageous in improving discharge performance. When a zinc alloy is used in the negative electrode, a self-dissolution rate in an alkaline electrolytic solution is decreased to inhibit hydrogen gas generation, and thus, safety can be improved.

The shape of the negative electrode material is not especially limited, and is preferably a powder shape, and thus, the surface area is increased to cope with large current discharge. A preferred average particle size of the negative electrode material is, in using a zinc alloy, in a range of 3 to 100 μm in minor axis, and when the average particle size is within this range, the surface area is so large that large current discharge can be suitably coped with, and in addition, the material can be easily homogeneously mixed with an electrolytic solution and a gelling agent, and handleability in assembling the battery is favorable.

It is preferable that the negative electrode 14 further includes a negative electrode current collector 15, and that the negative electrode current collector 15 has the negative electrode current collector tab 15a extending from an end (for example, an upper end) of the negative electrode 14. The negative electrode current collector tab 15a is provided preferably in a position not overlapping with the positive electrode current collector tab 13. The nickel-zinc secondary battery 10 preferably further includes a negative electrode current collector plate connected to a tip of the negative electrode current collector tab 15a, and more preferably, a plurality of negative electrode current collector tabs 15a are connected to one negative electrode current collector plate. In this manner, current collection can be space efficiently conducted with a simple configuration, and connection to a negative electrode terminal 28 is also eased. Besides, the negative electrode current collector plate itself may be used as the negative electrode terminal 28.

Preferable examples of the negative electrode current collector 15 include a copper foil, a copper expanded metal, and a copper punched metal, and a copper expanded metal is more preferred. In this case, for example, a negative electrode plate including a negative electrode/negative electrode current collector can be favorably produced by applying, on a copper expanded metal, a mixture containing a zinc oxide powder and/or a zinc powder, and optionally a binder (for example, a polytetrafluoroethylene particle). At this point, it is also preferred that the dried negative electrode plate (namely, the negative electrode/negative electrode current collector) is subjected to pressing to prevent the electrode active material from coming off and to improve electrode density.

An electrolyte retention member may be provided to cover or wrap up the positive electrode 12 and/or the negative electrode 14. In this manner, the electrolytic solution 18 can be uniformly present between the positive electrode 12 and/or the negative electrode 14, and the separator 16. Accordingly, hydroxide ions can be efficiently transferred between the positive electrode 12 and the separator 16, and/or between the negative electrode 14 and the separator 16. The electrolyte retention member is not especially limited as long as it is a member capable of retaining the electrolytic solution 18, and is preferably a sheet-shaped member. Preferable examples of the electrolyte retention member include a nonwoven fabric, a water-absorbent resin, an electrolyte retention resin, a porous sheet, and various spacers, and a nonwoven fabric is particularly preferable because a high performance negative electrode structure can be thus produced at low cost. Accordingly, it is most preferable that a nonwoven fabric (for example, a vinylon nonwoven fabric) used as the oxygen absorber 17 is used as the electrolyte retention member. As described above, the term “nonwoven fabric” used herein refers to a sheet-shaped product obtained by entangling, without weaving, fibers with one another, and encompasses not only those designated as nonwoven fabrics but also those designated as paper, namely, how it is called does not matter.

The electrolyte retention member or the nonwoven fabric (that can be the oxygen absorber 17) has a thickness of preferably 10 to 200 μm, more preferably 20 to 200 μm, further preferably 20 to 150 μm, particularly preferably 20 to 100 μm, and most preferably 20 to 60 μm. When the thickness falls in the above-described range, with the entire size of the negative electrode structure efficiently suppressed to be compact, a sufficient amount of the electrolytic solution 18 can be retained in the electrolyte retention member.

The separator 16 is provided to be interposed between the positive electrode 12 and the negative electrode 14. As the separator 16, any separator generally used in an alkaline secondary battery or a zinc secondary battery may be used, a microporous film separator (made of, for example, a polyolefin such as polyethylene, or polypropylene) may be used, and a hydroxide ion conductive separator such as an LDH separator is preferably used because penetration of zinc dendrite can be blocked while selectively permeating hydroxide ions. When a hydroxide ion conductive separator is used, it is preferable to employ a configuration in which both or one of the positive electrode 12 and the negative electrode 14 are covered or wrapped up with the hydroxy ion conductive separator 16 as illustrated in FIG. 2. When such a configuration is employed, complicated sealing and bonding between the hydroxide ion conductive separator 16 and the battery container is unnecessary, so that a nickel-zinc secondary battery (especially a stacked-cell battery thereof) capable of preventing zinc dendrite propagation can be produced extremely easily and with high productivity. It goes, however, without saying that a simple configuration in which the hydroxide ion conductive separator 16 is provided on the side of one surface of the positive electrode 12 or the negative electrode 14 may be employed.

The hydroxide ion conductive separator 16 is not especially limited as long as it is a separator capable of separating the positive electrode 12 and the negative electrode 14 such that hydroxide ions can be conducted, and representatively is a separator that contains a hydroxide ion conductive solid electrolyte, and selectively allows hydroxide ions to pass by solely utilizing hydroxide ion conductivity. A preferred hydroxide ion conductive solid electrolyte is a layered double hydroxide (LDH) and/or an LDH-like compound. Accordingly, the hydroxide ion conductive separator 16 is preferably an LDH separator. The “LDH separator” herein is a separator containing an LDH and/or an LDH-like compound, and is defined as a separator that selectively allows hydroxide ions to pass by solely utilizing hydroxide ion conductivity of the LDH and/or the LDH-like compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds. The LDH separator is preferably composited with a porous substrate. Accordingly, it is preferred that the LDH separator further includes a porous substrate, and is composited with the porous substrate with the LDH and/or the LDH-like compound filled in pores in the porous substrate. In other words, in a preferred LDH separator, the LDH and/or the LDH-like compound clogs up pores in the porous substrate so that hydroxide ion conductivity and gas impermeability can be exhibited (thereby the LDH separator can function as an LDH separator exhibiting hydroxide ion conductivity). The porous substrate is preferably made of a polymer material, and the LDH is particularly preferably incorporated over the entire area in the thickness direction of the porous substrate made of a polymer material. For example, known LDH separators disclosed in Patent Literatures 1 to 5 can be used. The thickness of the LDH separator is preferably 5 to 100 μm, more preferably 5 to 80 μm, further preferably 5 to 60 μm, and particularly preferably 5 to 40 μm.

When the positive electrode 12 and/or the negative electrode 14 are covered or wrapped up with the electrolyte retention member (that can be the oxygen absorber 17) and/or the separator 16, outer edges thereof (excluding a side on which the positive electrode current collector tab 13 or the negative electrode current collector tab 15a is extended) are preferably closed. In this case, closed sides of the outer edges of the electrolyte retention member and/or the separator 16 are preferably realized by bending the electrolyte retention member and/or the separator 16, or sealing the edges of the electrolyte retention member and/or the edges of the separator 16. Preferred examples of the sealing method include an adhesive, thermal welding, ultrasonic welding, an adhesive tape, a sealing tape, and a combination thereof. In particular, an LDH separator including a porous substrate made of a polymer material has flexibility, and hence is advantageously easily bent, and therefore, it is preferred that the LDH separator formed into a rectangular shape is bent to obtain a state where one side of the outer edges is closed. For thermal welding and ultrasonic welding, a commercially available heat sealer or the like may be used, and in sealing the edges of an LDH separator, it is preferred to perform the thermal welding and the ultrasonic welding with an outer circumferential portion of the electrolyte retention member sandwiched between outer circumferential portions of the LDH separator because the sealing can be thus more effectively performed. On the other hand, as an adhesive, an adhesive tape, and a sealing tape, commercially available products may be used, and in order to prevent deterioration otherwise caused in an alkaline electrolytic solution, one containing an alkali resistant resin is preferred. From this point of view, preferred examples of the adhesive include an epoxy resin-based adhesive, a natural resin-based adhesive, a modified olefin resin-based adhesive, and a modified silicone resin-based adhesive, among which an epoxy resin-based adhesive is more preferred because of excellent alkali resistance. An example of products of the epoxy resin-based adhesive includes an epoxy adhesive, Hysol® (manufactured by Henkel).

The electrolytic solution 18 preferably contains an alkali metal hydroxide aqueous solution. Although the electrolytic solution 18 is merely locally illustrated in FIG. 2, this is because the electrolytic solution spreads all over the positive electrode 12 and the negative electrode 14. Examples of an alkali metal hydroxide include potassium hydroxide, sodium hydroxide, lithium hydroxide, and ammonium hydroxide, and potassium hydroxide is more preferred. In order to inhibit self-dissolution of zinc and/or zinc oxide, a zinc compound such as zinc oxide, or zinc hydroxide may be added to the electrolytic solution. As described above, the electrolytic solution may be mixed with the positive electrode active material and/or the negative electrode active material so as to be present in the form of a positive electrode mixture and/or a negative electrode mixture. Besides, the electrolytic solution may be gelled for preventing leakage of the electrolytic solution. As a gelling agent, a polymer that absorbs a solvent of the electrolytic solution to swell is preferably used, and a polymer such as polyethylene oxide, polyvinyl alcohol, or polyacrylamide, or starch is used.

The battery components 11 are preferably formed, as illustrated in FIG. 2, into a positive/negative electrode laminate including a plurality of positive electrodes 12, a plurality of negative electrodes 14, and a plurality of separators 16 in which a unit of the positive electrode 12/the separator 16/the negative electrode 14 is repeatedly stacked. In other words, it is preferred that the nickel-zinc secondary battery 10 includes a plurality of unit cells 10a, and thus, the plurality of unit cells 10a form a multilayer cell as a whole. This is a configuration of what is called a battery pack or stacked cell battery, and this configuration is advantageous in obtaining a high voltage and a large current.

The sealed container 20 is preferably made of a resin. The resin constituting the sealed container 20 is preferably a resin having resistance to an alkali metal hydroxide such as potassium hydroxide, more preferably a polyolefin resin, an ABS resin, or modified polyphenylene ether, and further preferably an ABS resin or modified polyphenylene ether. The sealed container 20 has a top cover 20a. The sealed container 20 (for example, the upper cover 20a) may have a pressure release valve for releasing a gas. Besides, a container group in which two or more sealed containers 20 are arranged may be housed in an outer frame to obtain a configuration of a battery module.

### EXAMPLES

The present invention will be further specifically described with reference to the following examples.

### Example 1 (Comparative)

### (1) Production of Nickel-zinc Secondary Battery

A positive electrode plate, a negative electrode plate, an LDH separator, a nonwoven fabric, a battery case, and an electrolytic solution as follows were prepared.
Positive electrode plate: a plate having a thickness of 0.7 mm obtained by filling pores of foam nickel with a positive electrode paste containing nickel hydroxide and a binder, and drying the resultant (in which an uncoated portion having no positive electrode paste applied thereon is pressed in the vicinity of one end side of the foam nickel to be processed into a positive electrode current collector tab).
Negative electrode plate: one obtained by pressure-bonding, to a current collector (copper expanded metal), a negative electrode paste containing 92.7% by volume of a ZnO powder, 2.9% by volume of a metal Zn powder, 3.1% by volume of polytetrafluoroethylene (PTFE), and propylene glycol (in which an uncoated portion having no negative electrode paste applied thereon is present in the vicinity of one end side of the copper expanded metal as a negative electrode current collector tab).
Microporous film separator: a commercially available polypropylene microporous film separator, thickness: 20 μm
Nonwoven fabric: a commercially available polypropylene nonwoven fabric, thickness: 100 μm
Battery case: a housing made of a modified polyphenylene ether resin
Electrolytic solution: a 5.4 mol/L KOH aqueous solution in which 0.4 mol/L ZnO is dissolved

The positive electrode plate was wrapped up from the both surfaces with the nonwoven fabric in such a manner as to cause the nonwoven fabric to slightly protrude from three sides excluding a side on which a positive electrode current collector tab extended. Excessive portions of the nonwoven fabric thus protruded from the three sides of the negative electrode plate were thermally welded with a heat seal bar to obtain a positive electrode structure. Besides, the negative electrode plate was wrapped up from the both surfaces successively with the nonwoven fabric and the microporous separator in such a manner as to cause the nonwoven fabric and the microporous film separator to slightly protrude from three sides excluding a side on which a negative electrode current collector tab extended. Excessive portions of the nonwoven fabric and the microporous film separator thus protruded from the three sides of the positive electrode plate were thermally welded with a heat seal bar to obtain a negative electrode structure. In this manner, 25 electrode structures in total including 12 positive electrode structures and 13 negative electrode structures were prepared. The positive electrode structures and the negative electrode structures were alternately stacked to be arranged in the battery case. A positive electrode current collector and a negative electrode current collector were respectively connected to a positive electrode current collector terminal and a negative electrode current collector terminal, and the resin case and a resin cover were integrated with each other by thermal welding. Thereafter, the electrolytic solution was added through an electrolyte inlet, and was sufficiently impregnated in the positive electrode plates and the negative electrode plates by evacuation or the like. Thereafter, the electrolyte inlet was closed to obtain a sealed cell.

### (2) Evaluation of Calendar Durability Performance

A charge/discharge system (manufactured by Toyo System Co., Ltd., TOSCAT 3100) was used to subject the sealed cell to chemical conversion by 0.1 C charge and 0.2 C discharge. Thereafter, 0.5 C charge/discharge was conducted, and initial discharge capacity was measured at 25° C. After the measurement of the discharge capacity, the sealed cell was charged to 50% SOC, the cell in this charged state was stored for 30 days under an environment of 65° C., and then the discharge capacity was measured in the same manner as described above. Here, a ratio of the discharge capacity after the storage to the initial discharge capacity was calculated as a discharge capacity retention (%). This series of operations were repeated until the discharge capacity retention was lowered to 70% or less. The number of days elapsed until the discharge capacity retention was lowered to 70% or less was evaluated as an index corresponding to calendar durability performance. Higher calendar durability performance means longer calendar life. The temperature during the storage was set to a high temperature of 65° C. in order to acceleratedly evaluate the calendar durability performance and the calendar life.

### Example 2 (Comparative)

A battery was produced and evaluated in the same manner as in Example 1 except that the following LDH separator was used as a separator instead of the microporous film.
LDH separator: one obtained by depositing, by hydrothermal synthesis, Ni—Al—Ti-LDH (layered double hydroxide) in pores and on a surface of a polyethylene microporous film, and roll pressing the resultant, thickness: 9 μm

### Example 3

A battery was produced and evaluated in the same manner as in Example 2 except that a vinylon nonwoven fabric (product name: BFN No. 2, manufactured by Kuraray Co., Ltd., thickness: 84 μm) was used, instead of the polyolefin nonwoven fabric, as an oxygen absorber in the form of a nonwoven fabric covering the positive electrode plate and the negative electrode plate.

### Results

Table 2 shows results obtained in Examples 1 to 3. Calendar life of each example was calculated as a relative value to the calendar life (the number of days elapsed until the discharge capacity retention was lowered to 70% or less) obtained in Example 1.

TABLE 2

| | | | | Calendar |
|---|---|---|---|---|
| | | | | durability |
| | | Material of | | performance |
| | Oxygen | nonwoven | Type of | (relative value |
| | absorber | fabric | separator | to Example 1) |
| Ex. 1 | not used | Polyolefin | Microporous | 1.0 |
| (comparative) | | | separator | |
| Ex. 2 | not used | Polyolefin | LDH separator | 1.0 |
| (comparative) | | | | |
| Ex. 3 | used | Vinylon | LDH separator | 1.5 |
| | | (oxygen | | |
| | | absorber) | | |

It is understood, based on the results shown in Table 2, that the calendar durability performance, namely, calendar life, is improved by 1.5 times in Example 3 (Example) using an oxygen absorber of vinylon as compared with in Examples 1 and 2 (Comparative Examples) not using an oxygen absorber of vinylon.

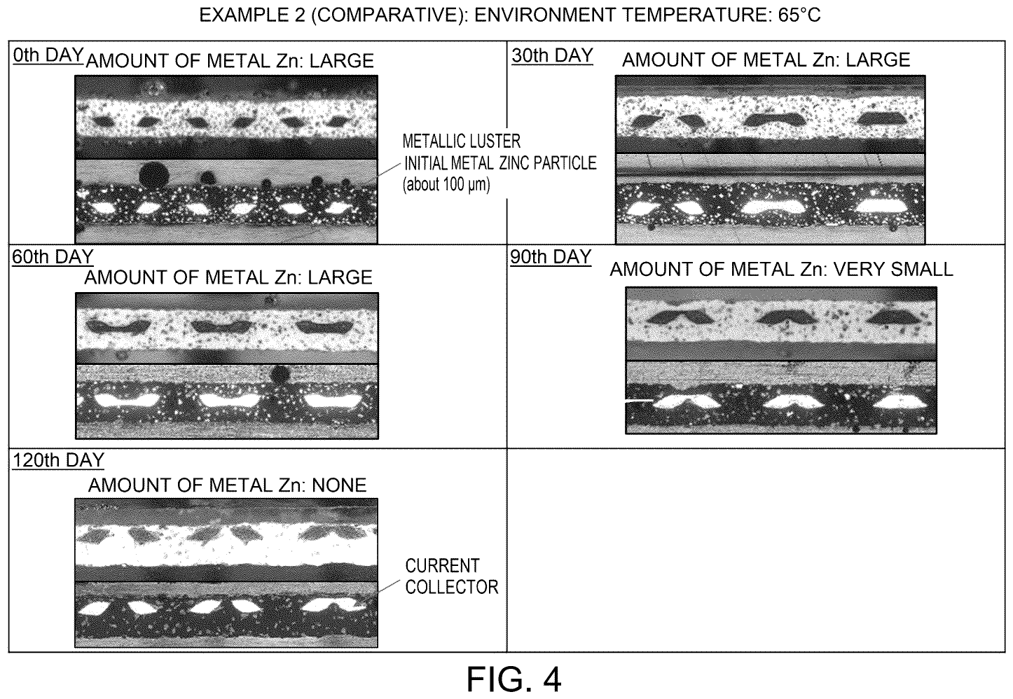

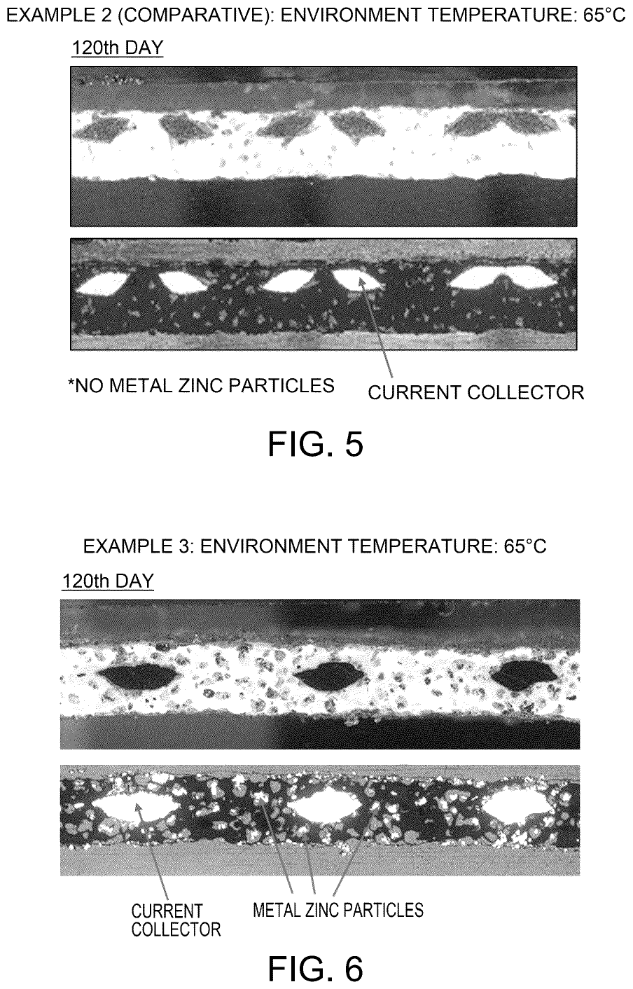

Besides, FIG. 4 illustrates optical microscope images (bright-field observation images in upper portions, dark-field observation images in lower portions) obtained by observation of a cross section of the negative electrode of the nickel-zinc secondary battery produced in Example 2 (comparative) at an initial time point (0th day), and time points after storing the battery at 65° C. for 30 days, 60 days, 90 days, and 120 days, and FIGS. 5 and 6 respectively illustrate optical microscope images (bright-field observation image in upper portion, dark-field observation images in lower portion) obtained by observation of the cross section of the negative electrode of the nickel-zinc secondary batteries produced in Examples 2 and 3 after storage at 65° C. for 120 days. It is understood, from FIGS. 4 and 5, that metal zinc particles (particle size: about 100 μm) observed as white metallic luster at the initial time point (0th day) in Example 2 (Comparative Example) not using an oxygen absorber of vinylon have substantially eliminated after elapse of 90 days, and that metal zinc was completely eliminated on and after the 120th day. On the contrary, large particles of initial metal zinc still remained even after elapse of 120 days under an environment of 65° C. in Example 3 (Example) using an oxygen absorber of vinylon as shown in FIG. 6, and thus, it is understood that consumption of the negative electrode capacity was suppressed. These facts are consistent with the effect of improving calendar life by the oxygen absorber shown in Table 2.

What is claimed is:

1. A nickel-zinc secondary battery, comprising, in a sealed container, a positive electrode, a negative electrode, a separator provided between the positive electrode and the negative electrode, and an electrolytic solution,
wherein an oxygen absorber is provided in a position where oxygen generated in the positive electrode in the sealed container is absorbable.

2. The nickel-zinc secondary battery according to claim 1, wherein the position where oxygen generated in the positive electrode is absorbable is at least one selected from the group consisting of a surface or surrounding of the positive electrode, a surface or surrounding of the negative electrode, a position between the positive electrode and the negative electrode, a surface or surrounding of the separator, an inner wall of the sealed container, a surface of a positive electrode current collector tab extending from the positive electrode, a surface of a negative electrode current collector tab extending from the negative electrode, and an extra space in the sealed container.

3. The nickel-zinc secondary battery according to claim 1, wherein the oxygen absorber is at least one selected from the group consisting of a metal powder, titanium dioxide, cerium oxide, a transition metal salt, a ferrous salt, a dithionite salt, zeolite, vinylon, benzenetriol, a polyhydric phenol compound, a polyhydric alcohol compound, an ascorbic acid compound, a cyclohexene compound, a polyene-based polymer having an unsaturated double bond, and an ethylene-vinyl alcohol copolymer.

4. The nickel-zinc secondary battery according to claim 1, wherein the oxygen absorber is in the form of a nonwoven fabric, and the positive electrode and/or the negative electrode is covered with the nonwoven fabric.

5. The nickel-zinc secondary battery according to claim 4, wherein the nonwoven fabric contains vinylon.

6. The nickel-zinc secondary battery according to claim 1, wherein the positive electrode contains nickel hydroxide and/or nickel oxyhydroxide, and the negative electrode contains zinc and/or zinc oxide.
